(19) United States
(12) Patent Application Publication
(10) Pub. No.: US 2002/0105509 A1
(43) Pub. Date: Aug. 8, 2002

(54) Display device

(75) Inventors: Mark Thomas Johnson, Eindhoven (NL); Dirk Kornelis Gerhardus De Boer, Eindhoven (NL); Johannes Albertus Matthijs Maria Van Haaren, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/061,085

(22) Filed: Feb. 1, 2002

(30) Foreign Application Priority Data
Feb. 2, 2001 (EP) 01200383.6

(51) Int. Cl. G09G 5/00

(52) U.S. Cl. 345/204

(57) ABSTRACT

The effect of twisting motion of LC molecules in multi-domain pixels of vertically aligned nematic LCDs, which leads to image retention, is reduced by applying a reset pulse which reduces the LCD voltage to below threshold. Several methods of reset (multiple counter electrodes, reset from column drivers, direct block reset, reset via storage capacitor line) are possible.

The invention relates to a liquid crystal display device comprising a liquid crystal material having a negative dielectric anisotropy between two substrates, one substrate of which is provided with a matrix of selection electrodes and data electrodes with a pixel at the area of a crossing of the selection electrodes and data electrodes, said pixels having a plurality of domains and at least one switching element, and further comprising drive means for driving the selection electrodes and data electrodes.

Examples of such active matrix display devices are TFT-LCDs or AM-LCDs which are used in laptop computers and in organizers and are based on a homeotropic effect, for example, the “vertically aligned effect”.

The pixels may be divided into domains in different ways, for example, by means of gaps in the picture electrodes or by local or non-local protrusions.

A problem in such display devices is the occurrence of after images. An image which is replaced by another image is then still visible for a longer time (sometimes up to several seconds), which has a very irritating effect.

It is an object of the present invention to provide a display device of the type described in the opening paragraph, in which after images do not occur or hardly occur.

To this end, a display device according to the invention comprises further drive means for applying a reset voltage across the pixels.

The invention is based on the recognition that two mechanisms are presumably active during switching of a pixel from the homeotropic state (voltage 0 volt or very low voltage) to the nematic state.

Due to the drive voltage, the liquid crystal molecules are subjected to an electric field which is transverse to the electrodes and realizes a very fast tilting movement. Moreover, the gaps and/or protrusions produce electric field components in a plane which is substantially parallel to the substrates (in-plane field). After the fast change of the tilt, the liquid crystal molecules are twisted in a much slower order (1 or more sec). Retwisting also takes place at an order of about 1 msec and thus causes the after images.

According to the invention, the original twist may be avoided by means of reset pulses which can be realized in different ways. It is, for example, possible that the further drive means apply a reset voltage across all pixels during non-selection of pixels.

It is alternatively possible to apply a reset voltage across at least a part of the pixels via data electrodes during selection of pixels. In this case, the further drive means may apply a reset voltage via data electrodes across at least a part of the pixels during selection of one or more rows of pixels, but this may also be done via parts of a counter electrode.

In a preferred embodiment, a pixel is provided with a storage capacitance and, prior to selection of pixels, the further drive means apply a reset voltage across the pixels via the storage capacitance.

In this application, the phrase “provided with a storage capacitance” is understood to mean that there is a coupling via an (auxiliary) capacitor, for example, by (partial) overlap of a picture electrode associated with a row and a part of the row electrode associated with a subsequent (or previous) row.

The further drive means may apply a reset voltage across the pixels via a connection electrode of the storage capacitance or via an adjacent selection electrode connected to the storage capacitance.

These and other aspects of the invention are apparent from and will be elucidated with reference to the embodiments described hereinafter.

In the drawings:

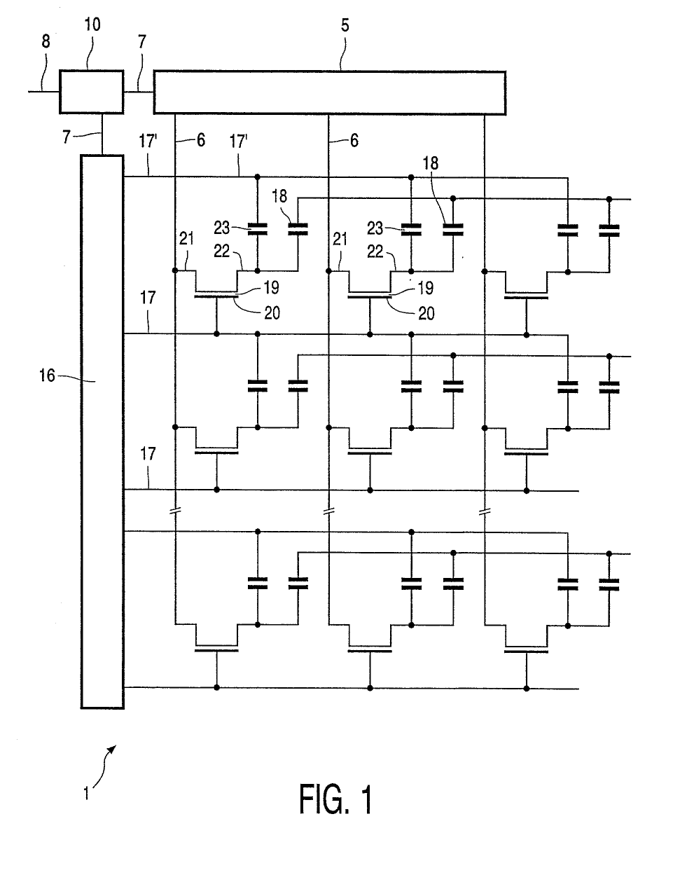

FIG. 1 is an electric circuit diagram of the display device,

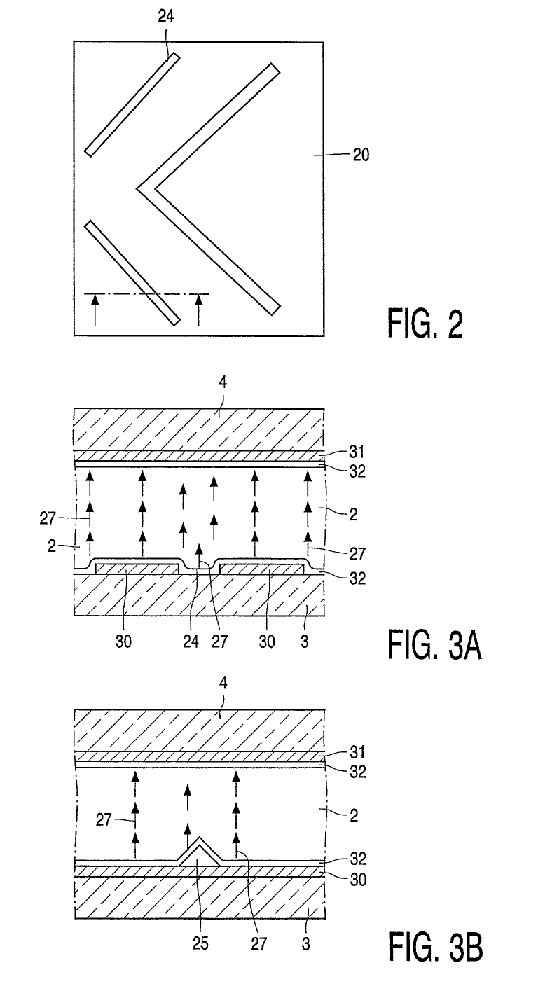

FIG. 2 is a plan view of a picture electrode in a display device according to the invention,

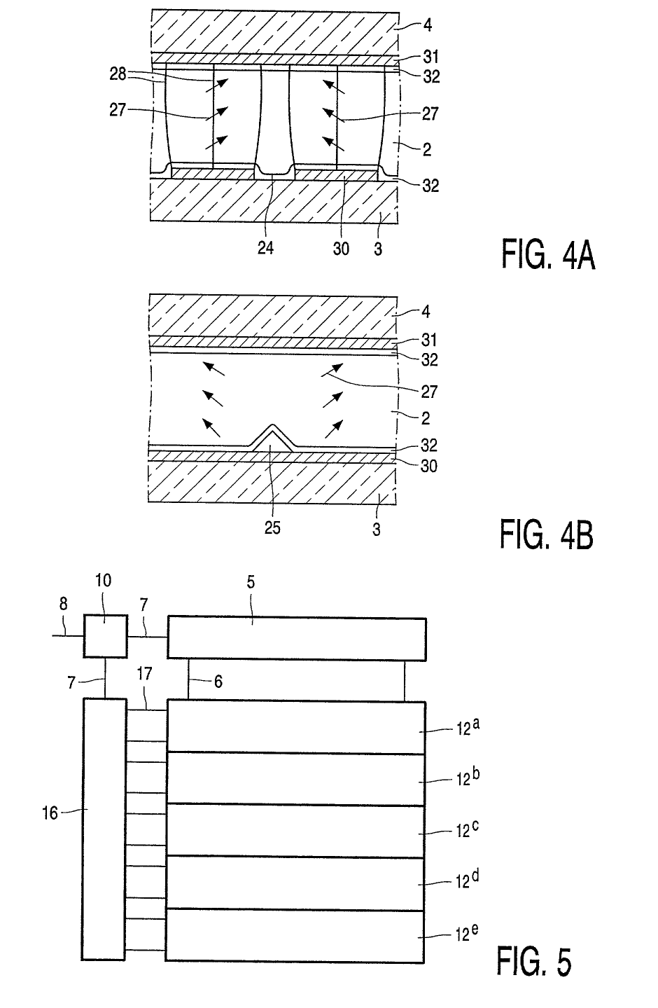

FIGS. 3 and 4 show the effect on the response of such a display device, while

FIG. 5 shows a part of a pixel.

The Figures are diagrammatic and not drawn to scale; corresponding parts are generally denoted by the same reference numerals.

FIG. 1 is an electric equivalent circuit diagram of a part of a display device 1 to which the invention is applicable. It comprises a matrix of pixels 18 at the area of crossings of row or selection electrodes 17 and column or data electrodes 6. The row electrodes are consecutively selected by means of a row driver 16, while the column electrodes are provided with data via a data register 5. To this end, incoming data 8 are first processed, if necessary, in a processor 10. Mutual synchronization between the row driver 16 and the data register 5 takes place via drive lines 7.

Drive signals coming from the row driver 16 select the picture electrodes via thin-film transistors (TFTs) 19 whose gate electrodes 20 are electrically connected to the row electrodes 17 and the source electrodes 21 are electrically connected to the column electrodes. The signal which is present at the column electrode 6 is transferred via the TF to a picture electrode of a pixel 18 coupled to the drain electrode 22. The other picture electrodes are connected to, for example, one (or more) common counter electrode(s).

The display device of FIG. 1 also comprises an auxiliary capacitor 23 at the location of each pixel. In this embodiment, the auxiliary capacitor is connected between the common point of the source electrode 21 and the pixel in a given row of pixels at one end, and the row electrode of the previous row of pixels at the other end; other configurations are alternatively possible, for example, between said common point and the next row of pixels, or between this point and an electrode for a fixed (or variable) voltage.

In this embodiment, the display device comprises an extra row electrode 17′ so as to prevent picture deviations.

FIG. 2 is a plan view and FIG. 3 is a cross-section taken on the line III-III in FIG. 2 of a part of a liquid crystal material 2 which is present between two substrates 3, 4 of, for example, glass or (flexible) synthetic material, provided with (ITO or metal) picture electrodes 30 and a counter electrode 31, respectively. The device also comprises orientation layers 32 which orient the liquid crystal material on the inner walls of the substrates. Moreover, the device comprises a polarizer (not shown) and a (mutually perpendicularly crossed) analyzer. In this case, the liquid crystal material is a (twisted) nematic material having a negative dielectric anisotropy. The picture electrodes also have narrow apertures 24. No light is transmitted (normally black) between crossed polarizers in this state. As will be further described, the apertures serve for obtaining the “wide viewing angle” effect. The same effect is obtained by using protrusions 25 (see FIG. 3B) instead of the apertures 24.

At zero voltage across a pixel, the (directors 27 of the) liquid crystal molecules are oriented perpendicularly to the substrates (negative dielectric anisotropy). Light transmitted by the polarizer is not influenced by the liquid crystal molecules and is passed by the analyzer.

Above a given threshold voltage, the liquid crystal molecules tilt and at a further increase of the voltage, the (directors 27 of the) liquid crystal molecules assume an angle with respect to the substrates (FIG. 4). This tilt is usually effected rapidly (about 10 msec). Due to the difference of refractive index and hence the effective path length for the normal and the abnormal component of an incident light beam, light is now passed by the analyzer. Due to “fringing fields” at the area of the apertures, the liquid crystal molecules tilt towards different directions, which enlarges the viewing angle (“wide viewing angle” effect).

When switching back to the dark state (or when switching between two intermediate states), “image retention” occurs in many cases (the images remain visible). This is presumably caused by a rotation of the (directors 27 of the) liquid crystal molecules under the influence of the electric field (field lines 28 in FIG. 4). This twist or rotating movement has a much larger time constant (about 1 sec, dependent on the history).

According to the invention, this twist or rotation may be entirely or partly eliminated by a reset pulse (for example, of a short duration and towards a lower voltage). There are various possibilities of realizing this.

For example, after an image has been written during a frame period, a reset voltage may be applied across all pixels during a subsequent frame period (via a voltage at the column electrodes or data electrodes).

It is also possible to apply a reset voltage across a part of the pixels via data electrodes during selection of pixels. In this case, the display device is divided into, for example, five segments 12a, 12b, 12c, 12d, 12e (FIG. 5). In such a segment, all lines of, for example, segment 12a are selected during reset, while the reset voltage is presented to the column electrodes. Such a segment is now reset in one line period and is performed once per frame period for each segment.

Alternatively, a reset voltage may be applied across pixels of the line (via a voltage at the column electrodes or data electrodes) during a line period for a (short) period of non-selection, prior to writing a line. This may lead to brightness variations in the image (artefacts). In the device of FIG. 1, such a reset pulse may also be generated capacitively by applying a reset pulse having the correct voltage and polarity to the row electrode 17 prior to the start of a selection period. Due to a capacitive kick-back effect, this reset pulse is transferred to the gate electrode 20, be it at a lower amplitude. By processing this in the choice of the amplitude of the original reset pulse across the row electrode 17, the pixels are reset. Instead of presenting the reset voltage via one counter electrode, the counter electrode 21 may be alternatively divided into parts corresponding to the segments 12, with the relevant part acquiring such a voltage during resetting that the pixels are reset.

In the embodiment of FIG. 1, the auxiliary capacitor 23 is connected between the common point of the drain electrode 22 and the pixel in a given row of pixels at one end, and the row electrode of the previous row of pixels at the other end. It may also be present between this point and a common electrode for all auxiliary capacitors. In that case, the reset voltage across the pixels is obtained by means of a reset pulse which is presented via this common electrode. Here again, a block-sequential reset is possible.

The protective scope of the invention is not limited to the embodiments described. Instead of the chevron shape of FIG. 2, the protrusions may also have X shapes, (combined) Y shapes or other conventional shapes.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A liquid crystal display device comprising a liquid crystal material having a negative dielectric anisotropy between two substrates, one substrate of which is provided with a matrix of selection electrodes and data electrodes with a pixel at the area of a crossing of the selection electrodes and data electrodes, said pixels having a plurality of domains and at least one switching element, and further comprising drive means for driving the selection electrodes and data electrodes, wherein the liquid crystal display device comprises further drive means for applying a reset voltage across the pixels.

2. A liquid crystal display device as claimed in claim 1, wherein the further drive means apply a reset voltage across all pixels between two frame periods.

3. A liquid crystal display device as claimed in claim 1, wherein the further drive means apply a reset voltage across at least a part of the pixels via data electrodes during a line selection period or a part of a line selection period.

4. A liquid crystal display device as claimed in claim 3, wherein the further drive means apply a reset voltage across all pixels via data electrodes.

5. A liquid crystal display device as claimed in claim 1, wherein a pixel is provided with a storage capacitance and, prior to selection of pixels, the further drive means apply a reset voltage across the pixels via the storage capacitance.

6. A liquid crystal display device as claimed in claim 5, wherein the further drive means apply a reset voltage across a part of the pixels via parts of a counter electrode during selection of pixels.

7. A liquid crystal display device as claimed in claim 6, wherein the further drive means apply a reset voltage across the pixels via a connection electrode of the storage capacitance.

8. A liquid crystal display device as claimed in claim 6, wherein the further drive means apply a reset voltage across the pixels via an adjacent selection electrode connected to the storage capacitance.
